(19) United States
(12) Patent Application Publication
(10) Pub. No.: US 2015/0094858 A1
(43) Pub. Date: Apr. 2, 2015

(54) WIRELESS CONTROL SENSING DEVICE AND MODULE

(71) Applicant: DELTA ELECTRONICS, INC., TAOYUAN HSIEN (TW)

(72) Inventors: Chun-Lin KUO, Taoyuan Hsien (TW); Cheng-Yen SHIH, Taoyuan Hsien (TW); Cheng-Nan WANG, Taoyuan Hsien (TW)

(73) Assignee: DELTA ELECTRONICS, INC., TAOYUAN HSIEN (TW)

(21) Appl. No.: 14/094,013

(22) Filed: Dec. 2, 2013

(30) Foreign Application Priority Data
Sep. 27, 2013 (CN) 201310449259.X

(51) Int. Cl. G05B 15/02

(52) U.S. Cl. CPC G05B 15/02
USPC 700/275

(57) ABSTRACT

A wireless control sensing device is disclosed. The sensing device has an instruction receiving unit and at least one sensing unit. The instruction receiving unit wirelessly receives an instruction signal, and then the sensing unit adjusts a sensing parameter of the sensing unit according to the received instruction signal.

### CROSS REFERENCE TO RELATED APPLICATIONS

This Non-provisional application claims priority under 35 U.S.C. §119(a) on Patent Application No(s). 201310449259.X filed in People's Republic of China on Sep. 27, 2013, the entire contents of which are hereby incorporated by reference.

### BACKGROUND OF THE INVENTION

1. Field of Invention

The present invention relates to a wireless control sensing device and a wireless control sensing device module.

2. Related Art

In general, the conventional sensing device is applied to announcement of visitors, controlling of lights or doors, management or the likes. The convention sensing device is usually configured with a control knob such as an exposed knob or screw, so that the control parameters of the sensing device (e.g. the response time, sensitivity or timer function) can be easily adjusted by manually rotating the knob or screw. However, this configuration needs some specific tools (e.g. a screw driver) for manually control the knob. In order to make the user more convenient, the control knob must be partially exposed. Unfortunately, the exposed component makes the waterproof design more difficult, so the conventional sensing device is not suitable for outdoor environment, which means the installation position of the conventional sensing device is limited. Besides, the adjustment of the conventional knob is made by the user based on the personal experience and the scales on the knob. Accordingly, the user can not precisely adjust the knob neither obtain an intuitional operation experience.

Therefore, it is an important subject to provide a sensing device that can be automatically controlled and has more flexible installation position and more intuitional control.

### SUMMARY OF THE INVENTION

In view of the foregoing, an objective of the present invention is to provide a wireless control sensing device and module.

To achieve the above objective, the present invention discloses a wireless control sensing device.

The sensing device of the invention includes an instruction receiving unit and at least one sensing unit. The instruction receiving unit wirelessly receives an instruction signal. Then, the at least one sensing unit receives the instruction signal and adjusts a sensing parameter of the sensing unit according to the instruction signal.

In one embodiment of the invention, the sensing device further comprises a control device for transmitting the instruction signal.

In one embodiment of the invention, the instruction receiving unit transmits a parameter signal or an environment signal to the control device, so a screen of the control device displays the adjusted sensing parameter or environment information. The environment information includes position information, a sensing state or a status of the sensing device. In one embodiment of the invention, the sensing unit comprises a thermal sensor, an IR sensor, a microwave sensor, a ultrasonic sensor, a photo sensor, or a mechanical touch sensor.

In one embodiment of the invention, the sensing parameter comprises response time, sensing frequency, sensitivity, sensing range, or sensing angle.

In one embodiment of the invention, the sensing device further comprises a light source electrically connected with the sensing unit, and the status of the light source is adjusted based on the sensing unit.

In one embodiment of the invention, the sensing device further comprises a status display unit electrically connected with the sensing unit.

In addition, the present invention also discloses a wireless control sensing device module comprising a plurality of the above-mentioned sensing devices. The instruction signal is transmitted between the sensing devices.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram showing a system structure of a wireless control sensing device of the present invention; and

FIG. 2 is a schematic diagram showing an application of a wireless control sensing device module of the present invention,

### DETAILED DESCRIPTION OF THE INVENTION

The present invention will be apparent from the following detailed description, which proceeds with reference to the accompanying drawings, wherein the same references relate to the same elements.

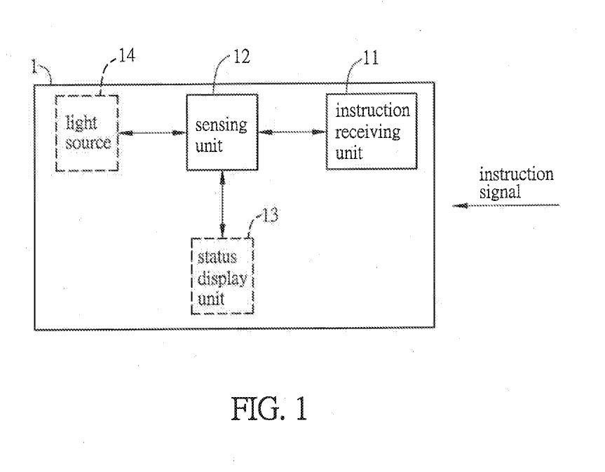

FIG. 1 is a schematic diagram showing a system structure of a wireless control sensing device 1 of the present invention.

Referring to FIG. 1, the wireless control sensing device 1 at least includes an instruction receiving unit 11 and at least one sensing unit 12.

The wireless control sensing device 1 may further include a control device (not shown) for transmitting an instruction signal to the sensing device 1. The control device can be an electronic device with a screen for displaying the sensing parameter and environment information of the sensing device 1. For example, the control device is a smart phone installed with a proper application program. Thus, the smart phone can be operated as a control device of the sensing device 1.

If the sensing device 1 is applied to the illumination field, it may further include a light source 14 electrically connected with the sensing unit 12. In this case, the status of the light source 14 can be adjusted based on the sensing unit 12. For example, when an object enters the detecting range of the sensing unit 12, the light source 14 is turned on.

In order to allow the user to determine the status of the sensing device 1 quicker and more intuitional, the sensing device 1 further includes a status display unit 13 electrically connected with at least one sensing unit 12. Herein, the status of the sensing device 1 can be shown by different color lights. For instance, when the status display unit 13 flashes a red light, it indicates that the sensing unit 12 is under a detection process; otherwise, when a green light of the status display unit 13 is turned on, it indicates that the instruction receiving unit 11 is connected to the control device.

In more specific, the instruction receiving unit 11 is electrically connected with at least one sensing unit 12. After receiving an instruction signal wirelessly, the instruction receiving unit 11 transmits the instruction signal to the sensing unit 12. Afterwards, the sensing unit 12 adjusts the sensing parameter of the sensing unit 12 according to the received instruction signal. Herein, the instruction receiving unit 11 may transmit a parameter signal or an environment signal to the control device, so a screen of the control device displays the adjusted sensing parameter or environment information. As a result, the user can catch the adjusted digital sensing parameter or environment information shown on the screen of the control device.

In brief, the above configuration allows the user to adjust the sensing parameter of the sensing unit 12 without manual operations. Besides, the details of the sensing parameter and adjustment thereof can be digitalized and shown on the screen of the control device, so that the user can properly adjust the sensing device more precisely and intuitionally. Moreover, since the configuration of the invention uses the wireless control mode, the instruction receiving unit 11 is installed inside the case of the sensing device 1, that is the control knob or control unit is not exposed. Accordingly, the sensing device of the invention has better waterproof and dustproof effects than ever, and thus it can be adapted to any environment.

In one embodiment, the sensing device includes two or more sensing units 12. In this case, the above-mentioned “control signal” enables to select a specific sensing unit 12 and then adjust the sensing parameter of the selected sensing unit 12.

To be noted, the process that the sensing unit 12 further provides the adjusted sensing parameter or environment signal to the control device does not to be executed immediately. In other words, it is not required to feedback the adjusted sensing parameter or environment signal, to the control device immediately. In practice, the control device may transmit a sensing parameter request signal or environment information request signal to the instruction receiving unit 11 as a parameter signal adjustment reference in every operation.

In addition, the present embodiment may configure with different sensing units 12, such as a thermal sensor, an IR sensor, a microwave sensor, a ultrasonic sensor, a photo sensor, or a mechanical touch sensor, based on different requirements. Any suitable sensing unit 12 can be applied to the sensing device 1 of the invention.

The “sensing parameter” may include, but not limited to, a response time (the time period for continuously turning on the light source 14), sensing frequency (the time interval for enabling the sensing unit 12), sensitivity, sensing range, or sensing angle.

The “environment information” includes position information, sensing state or status of the sensing device.

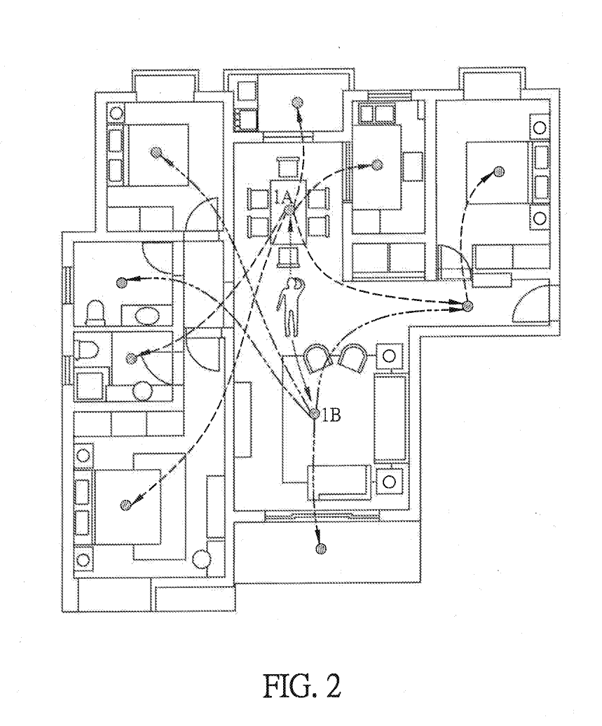

FIG. 2 is a schematic diagram showing an application of a wireless control sensing device module of the present invention.

Except for the above-mentioned application of a single sensing device, it is possible to connect a plurality of sensing devices 1 to form a network. In other words, multiple sensing devices 1 are connected to form a wireless control sensing device module. The instruction signal can be transmitted between the sensing devices.

After one of the sensing devices receives the instruction signal, for example, it may transmit the received instruction signal to the next sensing device. The sensing device adjusts the sensing parameter thereof according to the received instruction signal.

For instance, when entering a network effective area (e.g. a house configuring with a plurality of sensing devices), a user may operate the control device (e.g. a smart phone) to output an instruction to the sensing devices 1A and 1B for enabling or disabling the sensing devices 1A and/or 1B. After receiving the instruction, the sensing device 1A transmits another instruction signal to the next sensing device. For example, the sensing device 1A may transmit the position information of the user to other sensing devices so as to enable the other sensing devices to act proper responses. Similarly, the sensing device 1B can transmit another instruction signal to the next sensing device after receiving the instruction signal.

As mentioned above, the user can remotely control one or more sensing devices, and then the directly controlled sensing device commands the next or adjacent sensing devices so as to form a network for the user. Accordingly, the sensing devices can exchange and share the necessary information or signal and be induced the proper actions as well as the advanced control applications. For example, after sensing the position of the user, various kinds of home appliances such as lights, air conditions, doors, windows, curtains, TV and faucets can be controlled. This application can achieve many purposes such as intelligent control, power saving or security.

In summary, the present invention is to configure an instruction receiving unit and at least one sensing unit in a sensing device, so that the sensing device can be automatically controlled and has more flexible installation position and more intuitional control. In addition, several sensing devices can be coupled to form a sensing device module. Accordingly, the invention can directly and/or indirectly control the sensing devices under the same network.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A wireless control sensing device, comprising:
an instruction receiving unit wirelessly receiving an instruction signal; and
at least a sensing unit adjusting a sensing parameter of the sensing unit according to the received instruction signal.

2. The sensing device according to claim 1, further comprising a control device for transmitting the instruction signal.

3. The sensing device according to claim 2, wherein the instruction receiving unit transmits a parameter signal or an environment signal to the control device, so a screen of the control device displays the adjusted sensing parameter or an environment information.

4. The sensing device according to claim 3, wherein the environment information includes a position information, a sensing state or a status of the sensing device.

5. The sensing device according to claim 1, wherein the sensing unit comprises a thermal sensor, an IR sensor, a microwave sensor, a ultrasonic sensor, a photo sensor, or a mechanical touch sensor.

6. The sensing device according to claim 1, wherein the sensing parameter comprises a response time, a sensing frequency, a sensitivity, a sensing range, or a sensing angle.

7. The sensing device according to claim 1, further comprising a light source electrically connected with the sensing unit, wherein the status of the light source is adjusted based on the sensing unit.

8. The sensing device according to claim 1, further comprising a status display unit electrically connected with the sensing unit.

9. A wireless control sensing device module, comprising:
a plurality of sensing devices as recited in claim 1, wherein the instruction signal is transmitted between the sensing devices.

10. The wireless control sensing device module according to claim 9, wherein each of the sensing devices further comprises a control device for transmitting the instruction signal.

11. The wireless control sensing device module according to claim 10, wherein the instruction receiving unit transmits a parameter signal or an environment signal to the control device, so a screen of the control device displays the adjusted sensing parameter or an environment information.

12. The wireless control sensing device module according to claim 11, wherein the environment information includes a position information, a sensing state or a status of the sensing device.

13. The wireless control sensing device module according to claim 9, wherein the sensing unit comprises a thermal sensor, an IR sensor, a microwave sensor, a ultrasonic sensor, a photo sensor, or a mechanical touch sensor.

14. The wireless control sensing device module according to claim 9, wherein the sensing parameter comprises a response time, a sensing frequency, a sensitivity, a sensing range, or a sensing angle.

15. The wireless control sensing device module according to claim 9, wherein each of the sensing device further comprises a light source electrically connected with the sensing unit, and the status of the light source is adjusted based on the sensing unit.

16. The wireless control sensing device module according to claim 9, wherein each of the sensing devices further comprises a status display unit electrically connected with the sensing unit.
